(19) United States
(12) Patent Application Publication
(10) Pub. No.: US 2020/0401327 A1
(43) Pub. Date: Dec. 24, 2020

(54) Dynamic Allocation Of Storage From A Shared Storage Pool Across Different Redundancy Levels

(71) Applicant: Intelliflash by DDN, Inc., Santa Clara, CA (US)

(72) Inventors: Nabakishore Munda, Bangalore (IN); Shailendra Tripathi, Fremont, CA (US)

(21) Appl. No.: 16/445,152

(22) Filed: Jun. 18, 2019

(51) Int. Cl. G06F 3/06

(52) U.S. Cl. CPC G06F 3/0631; G06F 3/0619; G06F 3/0664; G06F 3/0683; G06F 3/0659

(57) ABSTRACT

Systems and methods are described for dynamically allocating digital data storage from a shared storage pool across multiple different redundancy configurations. Respective slabs of storage from a first set and from a second set of storage devices of a data storage system are allocated to a first virtual device having a first redundancy level and to a second virtual device having a second different redundancy level, where at least one of the slabs corresponding to each respective virtual device is from the same device. In response to write requests corresponding to the virtual devices, such as from a different application corresponding to each respective virtual device, data blocks from each respective slabs can be dynamically allocated to fulfill the requests. As such, redundancy/fault tolerant policies can effectively be set as a configurable property relative to each application that utilizes the data storage system.

### FIELD OF EMBODIMENTS

Embodiments of the invention may relate generally to data storage systems and, more particularly, to dynamic allocation of storage from a shared storage pool across different redundancy levels.

### BACKGROUND

In a storage pool (i.e., a pool of storage space from data storage devices from which storage is allocated to a redundancy group), data storage devices are typically configured to be part of a certain redundancy group such as a certain RAID (Redundant Array of Independent Disks, or Drives) group (e.g., RAID 1 (also referred to as a “Mirror”), RAID 5, RAID 6, etc.). As such, those particular data storage devices cannot be concurrently used for other redundancy purposes. Likewise, a corresponding storage pool is configured for only one of the RAID groups or any other redundancy scheme.

Any approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a block diagram illustrating a data storage system architecture, according to an embodiment;

FIG. 2 is a diagram illustrating a storage pool allocation architecture, according to an embodiment;

FIG. 3 is a flow diagram illustrating a method of allocating digital storage space from a shared storage pool, according to an embodiment;

FIG. 4A is a diagram illustrating a storage pool allocation, according to an embodiment; and

FIG. 4B is a diagram illustrating a slab map for storage pool allocation, according to an embodiment.

### DETAILED DESCRIPTION

Approaches to dynamically allocating storage space from a shared storage pool across multiple different redundancy levels are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

If used herein, the term “substantially” will be understood to describe a feature that is largely or nearly structured, configured, dimensioned, etc., but with which manufacturing tolerances and the like may in practice result in a situation in which the structure, configuration, dimension, etc. is not always or necessarily precisely as stated. For example, describing a structure as “substantially vertical” would assign that term its plain meaning, such that the sidewall is vertical for all practical purposes but may not be precisely at 90 degrees.

### Example Operating Environment: Data Storage System

There is a commercial demand for high-capacity digital data storage systems, in which multiple data storage devices (DSDs) are housed in a common enclosure. Data storage systems often include large enclosures that house multiple shelves on which rows of DSDs are mounted. A data storage system typically comprises a system enclosure, or “rack”, in which multiple data storage system trays are housed. Each tray may be placed or slid into a corresponding slot within the rack, which also houses one or more system controllers, and may further house switches, storage server(s), application server(s), a power supply, cooling fans, etc.

Embodiments described herein may be used in the context of a data storage system in which multiple data storage devices (DSDs), such as spinning disk hard disk drives (HDDs), and/or solid state drives (SSDs) (i.e., memory devices using non-volatile memory such as flash or other solid-state (e.g., integrated circuits) memory that is electrically erasable and programmable), and/or hybrid drives (i.e., multi-medium storage devices or “multi-medium device” or “multi-tier device”, all of which refer generally to a storage device having functionality of both a traditional HDD combined with an SSD), are employed.

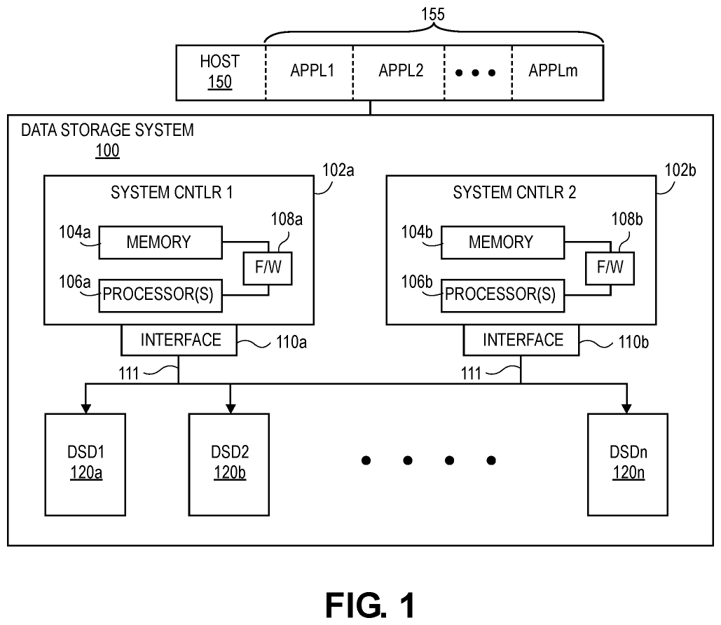

FIG. 1 is a block diagram illustrating a data storage system architecture, according to an embodiment. The example architecture of FIG. 1 illustrates a data storage system 100 that comprises multiple data storage devices (DSDs) 120a (DSD1), 120b (DSD2), and 120n (DSDn), where n represents an arbitrary number of DSDs that may vary from implementation to implementation. Each DSD 120a-120n is under the control of and communicative with one or more system controllers 102a, 102b via a respective communication interface 110a, 110b, according to a corresponding communication protocol 111. Each system controller 102a, 102b includes memory 104a, 104b (e.g., some form of RAM), a processor 106a, 106b, and stored firmware 108a, 108b which is executable by the respective processor 106a, 106b.

Processing, functions, procedures, actions, method steps, and the like, that are described herein as being performed or performable by system controller 102a, 102b may include enactment by execution of one or more sequences of instructions (e.g., embodied in firmware 108a, 108b) stored in one or more memory units (e.g., ROM inherent to firmware) and which, when executed by one or more processors (e.g., processor 106a, 106b), cause such performance. The executable sequences of instructions are not limited to implementation in firmware such as firmware 108a, 108b as exemplified in FIG. 1, but may be embodied in any form of and/or combination of hardware, software, and firmware. Each controller 102a, 102b may also be embodied in any form of and/or combination of hardware, software, and firmware. For example, and according to an embodiment, each system controller 102a, 102b may comprise an application-specific integrated circuit (ASIC) comprising at least one memory unit (e.g., ROM) for storing such instructions and at least one processor (e.g., processor 106a, 106b) for executing such instructions, enabling dynamic allocation of storage space from a shared storage pool across multiple different redundancy levels.

The data storage system 100 may be communicatively coupled with a host 150, which may be embodied in a hardware machine on which executable code is executable (for non-limiting examples, a computer or hardware server, and the like), or as software instructions executable by one or more processors (for non-limiting examples, a software server such as a database server, application server, media server, and the like). Host 150 generally represents a client of the data storage system 100, and has the capability to make read and write requests to the data storage system 100 on behalf of one or more applications 155 (depicted as APPL1, APPL2, APPLn, where n represents an arbitrary number of applications that may vary from implementation to implementation). Note that each system controller 102a. 102b may also be referred to as a “host” because the term is at times generally used in reference to any device that makes, passes through, or otherwise facilitates I/O calls to a data storage device or an array of devices.

### INTRODUCTION

Recall that with a typical storage pool, data storage devices and a corresponding storage pool are configured to be part of a certain redundancy group and that those particular data storage devices cannot be concurrently used for other redundancy purposes. Exceptions may include allowing creation of fixed size volumes/volume groups or fixed partitions of different redundancy schemes from a given set of storage devices. However, such volumes/partitions are “fixed”, as in relatively permanent with respect to the administrative effort needed to tear down a given volume/partition and to recreate new ones. Furthermore, within the same storage pool, all the associated applications experience the same performance and redundancy levels. The foregoing approaches may be considered inefficient with respect to storage space usage and data storage system performance, for example. Hence, dynamic allocation of space and movement of blocks across volumes and filesystems may be desirable.

### Dynamic Allocation of Storage Across Different Redundancy Levels

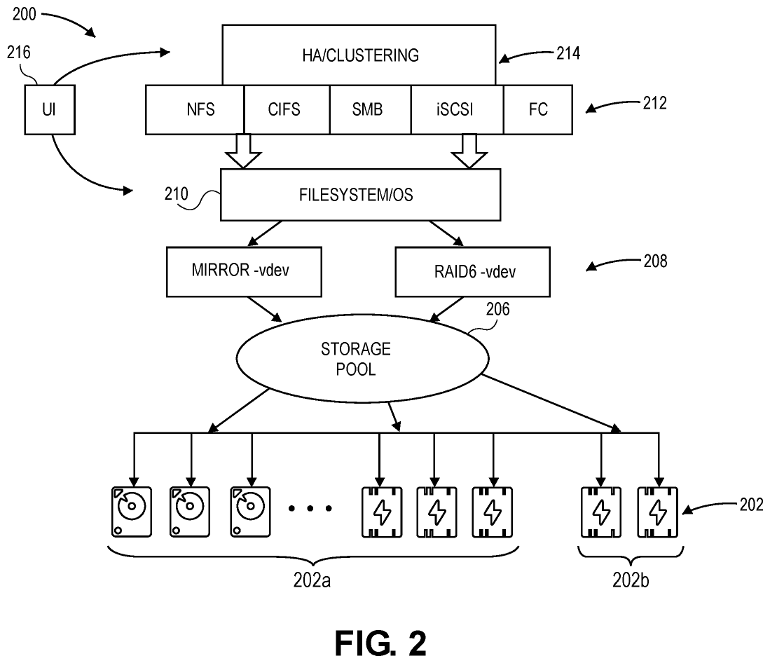

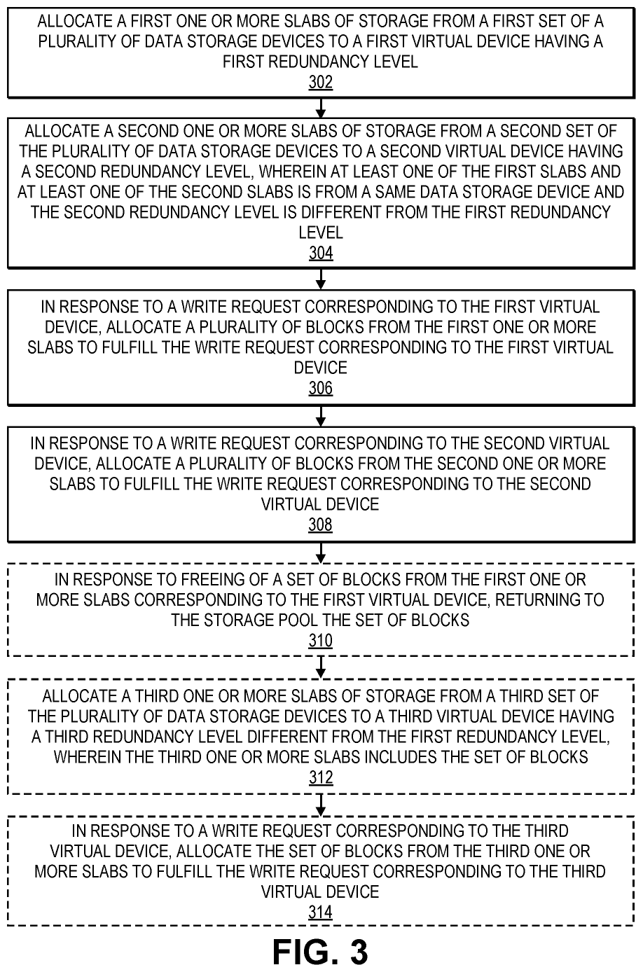

FIG. 2 is a diagram illustrating a storage pool allocation architecture, according to an embodiment. The method illustrated in FIG. 3 is described herein with reference to the example architecture of FIG. 2. Architecture 200 is described herein generally in terms of “layers”, which perform respective functions within the architecture, where each layer may take the form of physical devices, logical and/or virtual devices, abstractions, data structures, executable instructions, logical and/or physical redundancy schemes, network protocols, client applications, host applications and/or hardware, and the like.

At the lowest level depicted in FIG. 2, architecture 200 comprises a layer 202 comprising a plurality of data storage devices (DSDs) 202a, 202b (an arbitrary number shown), in the form of physical devices. The type(s) of DSDs 202a, 202b may vary from implementation to implementation. For non-limiting examples, DSDs 202a, 202b may be HDDs, and/or SSDs, and/or hybrid drives, and the like, or a combination of such devices. The DSDs 202a, 202b of layer 202 supply or provide the digital data storage space constituent to a storage pool 206 (e.g., a logical grouping or virtualization of physical storage) which, according to an embodiment, is shared among multiple redundancy levels or schemes (for non-limiting examples, a MIRROR filesystem (FS) and a RAID 6 volume). According to an embodiment, the DSDs 202a, 202b may be configured into hardware RAID0 groups, e.g., for striping. The storage pool 206 may be created, for example, on a group of DSDs 202a, metadata devices 202b, and/or cache devices (if any), and is utilized for different redundancy levels by one or more applications such as applications 155 (FIG. 1), which may be under the management and control of layer 214 (for non-limiting examples, high availability (HA) software, and/or clustering software), which may be commanded via a UI (user interface) 216. Layer 214 may communicate over a network with the lower layers via one or more storage network/file sharing/data transfer protocols of layer 212, such as NFS (Network File System), CIFS (Common Internet File System), SMB (Server Message Block), iSCSI (Internet Small Computer System Interface), FC (Fibre Channel), and the like. According to an embodiment, data maps describing slab allocation for a physical device are maintained in one or more separate metadata storage devices, such as metadata devices 202b, for enhanced performance in the context of mapping maintenance, for example.

According to an embodiment, a filesystem application and/or operating system (OS) layer 210 executes to allocate storage space from storage pool 206 to a plurality of RAID schemes, via use of virtual devices (vdev) of layer 208. That is, according to an embodiment, the filesystem/OS layer 210 logically configures the storage from the RAID0 DSDs 202a, 202b into vdevs of layer 208. For example and according to an embodiment, a volume or filesystem is created specifying each of the desired redundancy levels, such as the exemplary MIRROR FS and the RAID6 volume, and corresponding logical vdevs of layer 208, are created. According to an embodiment, layer 210 is configured for execution by or within a system controller product or part such as by system controller 102a, 102b (FIG. 1).

FIG. 3 is a flow diagram illustrating a method of allocating digital storage space from a shared storage pool, according to an embodiment. The process or procedure of FIG. 3 may be implemented for execution as one or more sequences of instructions stored in one or more memory units and which, when executed by one or more processors, cause performance of the process. For example, the sequences of instructions (e.g., embodied in firmware 108a, 108b of controller 102a, 102b of FIG. 1) stored in one or more memory units (e.g., ROM inherent to firmware) and which, when executed by one or more processors (e.g., processor 106a, 106b of controller 102a, 102b of FIG. 1), cause performance of the process illustrated in FIG. 3.

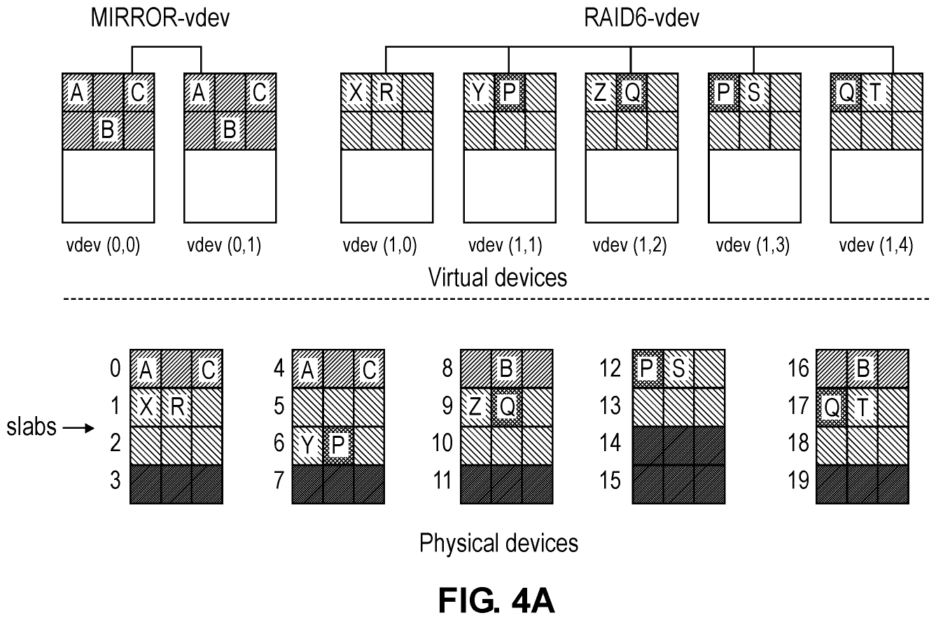

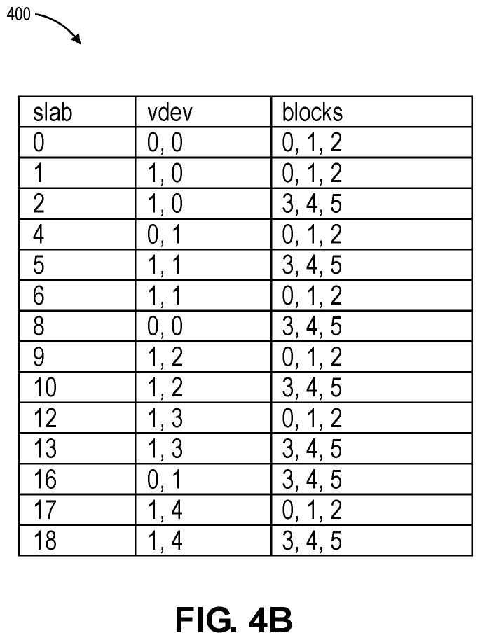

At block 302, a first one or more slabs of storage from a first set of a plurality of data storage devices (DSDs) is allocated to a first virtual device having a first redundancy level. For example, a first group of slabs (e.g., a group of contiguous blocks of digital storage, such as slabs 1-19 illustrated in FIG. 4A) from a first set of a plurality of data storage devices 202a (FIG. 2) is allocated from the storage pool 206 to a first virtual device (e.g., a MIRROR-vdev of layer 208 of FIG. 2) having a first redundancy level or configuration (e.g., the exemplary MIRROR (RAID1) filesystem (FS), having data mirroring without striping or parity). For example, an IT administrator operating from a user interface (e.g., UI 216 of FIG. 2) may set up or configure the data storage system 100 (FIG. 1) to include a MIRROR FS, via the filesystem/OS layer 210 (FIG. 2), to serve the storage needs of a particular application such as APPL1 (FIG. 1) and according to a particular redundancy level (e.g., RAID1).

According to an embodiment, the allocating of the first one or more slabs at block 302 further comprises (a) determining the number of slabs to meet the corresponding allocation request, and (b) determining the minimum number of the first set of DSDs to meet the first redundancy level. For example, in response to the administrator request to configure a 4 Gigabyte MIRROR FS, the filesystem/OS layer 210 can determine that eight 1-Gigabyte slabs from a combination of two DSDs is needed to meet the redundancy and storage allocation request.

At block 304, a second one or more slabs of storage from a second set of the plurality of data storage devices (DSDs) is allocated to a second virtual device having a second redundancy level or configuration, wherein at least one of the first slabs and at least one of the second slabs is from a same DSD and the first and second redundancy levels are different. For example, a second group of slabs (such as from slabs 1-19 illustrated in FIG. 4A) from a second set of the plurality of DSDs 202a is allocated from the storage pool 206 to a second virtual device (e.g., a RAID6-vdev of layer 208 of FIG. 2) having a second redundancy level (e.g., the exemplary RAID6 volume, having block level striping with double distributed parity), where the first and the second sets of DSDs have at least one DSD 202a in common. For example, an IT administrator operating from a user interface (e.g., UI 216) may set up or configure the data storage system 100 to include a RAID6 volume, via the filesystem/OS layer 210, to serve the storage needs of a particular application such as APPL2 and according to a particular redundancy level (e.g., RAID6). Furthermore, the redundancy schemes may be configured (e.g., by administrator) such that each application APPL1-APPLn corresponds to and solely uses a particular virtual device and corresponding redundancy level, or a group of applications may correspond to and share use of a particular virtual device and corresponding redundancy level.

At block 306, in response to a write request corresponding to the first virtual device, a plurality of blocks is allocated from the first one or more slabs to fulfill the write request corresponding to the first virtual device. For example, the filesystem/OS 210 dynamically allocates storage blocks (e.g., on demand, or on-the-fly) from corresponding slabs allocated to the MIRROR-vdev (layer 208) in response to a write request coming from the APPL1 as a client of the data storage system 100. Similarly at block 308, in response to a write request corresponding to the second virtual device, a plurality of blocks is allocated from the second one or more slabs to fulfill the write request corresponding to the second virtual device. For example, the filesystem/OS 210 dynamically allocates storage blocks (e.g., on demand, or on-the-fly) from corresponding slabs allocated to the RAID6-vdev (layer 208) in response to a write request coming from the APPL2 as a client of the data storage system 100.

Performance varies depending on the type of redundancy level configured. Read/Write performance will be best with RAID0 where the data is just striped across multiple devices and bandwidth from all devices is used, but RAID0 cannot recover from a single device failure. RAID1 can recover from a single device failure but its effective space usage is reduced to half and performance is also dropped. RAID5 and RAID6 have better space usage but their write performance is low. According to an embodiment, the performance of a virtual device may be increased by allocating one or more slabs of storage from an adjusted set of DSDs to the virtual device, where the adjusted set of DSDs comprises more DSDs than were originally associated with the virtual device. For example, an IT administrator may determine that better performance is desired from the second virtual device (RAID6-vdev) and make a request to the filesystem/OS 210 accordingly, whereby the filesystem/OS 210 allocates additional slabs (or replaces some existing slabs) from one or more DSDs that were not in the second set of DSDs originally corresponding to the second virtual device, to provide additional I/O bandwidth/throughput for the adjusted second virtual device.

At optional block 310, in response to the freeing of a set of blocks from the first one or more slabs corresponding to the first virtual device, the set of blocks is returned to the storage pool. For example, the filesystem/OS 210 and/or system controller 102a, 102b (FIG. 1) constantly tracks currently used and unused blocks so the filesystem/OS 210 is aware when blocks are marked as unused by all of the corresponding client applications (e.g., APPL1-APPLn). Hence, in response to a set of blocks being marked as unused, the filesystem/OS 210 can provision those blocks back into the storage pool 206 by characterizing, marking or otherwise associating them back into the pool and available for allocation/use.

At optional block 312, a third one or more slabs of storage from a third set of the plurality of data storage devices (DSDs) is allocated to a third virtual device having a third redundancy level or configuration that is different from the first redundancy level, and wherein the third one or more slabs includes the set of blocks from block 310. For example, a third group of slabs (such as from slabs 1-19 illustrated in FIG. 4A) from a third set of the plurality of DSDs 202a is dynamically allocated from the storage pool 206 to a third virtual device (e.g., a RAID4-vdev of layer 208, not specifically illustrated in FIG. 2) having a third redundancy level (e.g., an exemplary RAID4 volume, having block level striping with dedicated parity, not specifically illustrated in FIG. 2). Note, however, that the set of blocks reclaimed to the pool may be allocated to a different virtual device of the same redundancy level of the virtual device from which the blocks were freed. Notably, reallocating freed storage space in this manner can be performed dynamically, whereby recreation of a RAID configuration from scratch is avoided.

At optional block 314, in response to a write request corresponding to the third virtual device, the set of blocks is allocated from the third one or more slabs to fulfill the write request corresponding to the third virtual device. For example, the filesystem/OS 210 dynamically allocates storage blocks (e.g., on demand) from corresponding slabs allocated to the RAID4-vdev (layer 208) in response to a write request coming from the APPLn as a client of the data storage system 100.

### Storage Pool Allocation

FIG. 4A is a diagram illustrating a storage pool allocation, and FIG. 4B is a diagram illustrating a slab map for storage pool allocation, each according to embodiments. With reference first to the example of FIG. 4A, which illustrates the allocation of two stripes XYZPQ and RPQST (e.g., an assembly of slabs, or slices, across multiple physical disks or storage devices), where each block is coming from a different slab and device. Each virtual device is represented as vdev (x, y), where x represents the top-level group with the type of redundancy and y represents the device within the group, e.g., vdev (0, 0) represents the 0^{th} device within the RAID1-vdev and vdev (0, 1) represents the 1^{st} device within RAID1-vdev group. As mentioned, a group of contiguous blocks from a given storage device forms a slab. In the example of FIG. 4A, five physical devices are divided in to twenty slabs enumerated from 0 to 19, out of which fourteen slabs are allocated to different virtual devices, MIRROR-vdev and RAID6-vdev (the dark-hashed blocks from slabs 3, 7, 11, 14, 15, and 19 are not allocated). Thus, the allocation of the two stripes XYZPQ and RPQST across the five physical devices, and five corresponding slabs, for a RAID6-vdev is illustrated.

With reference now to FIG. 4B, slab maps are used to describe the slabs allocated for the virtual devices and which, according to an embodiment, reside on separate devices referred to as metadata devices (e.g., DSDs 202b of FIG. 2). Each entry in slab map 400 describes the slab number, the virtual device to which it belongs, and the logical blocks within the virtual device to which each slab maps. For example, slab 0 is allocated to vdev (0, 0) and maps to logical blocks 0, 1, 2 within vdev (0, 0) and, similarly, slab 18 is allocated to vdev (1, 4) and maps to logical blocks 3, 4, 5 within vdev (1, 4). Furthermore, slab 0 and slab 4 form a mirror pair. Note that in the scenario of a device failure, a slab map may be used to rebuild the data to a newly added DSD or to one of the existing DSDs.

Approaches described herein allow for dynamic allocation of storage space, and movement of blocks across different volumes and filesystems and across volumes and filesystems having different redundancy levels. As such, these approaches effectively provide for redundancy/fault tolerant policies as a configurable property relative to each application that utilizes the data storage system. Hence, providing different levels of performance (e.g., Quality of Service, or QoS) for different applications running on the same storage array and storage pool is enabled.

### EXTENSIONS AND ALTERNATIVES

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process operations may be set forth in a particular order, and alphabetic and alphanumeric labels may be used to identify certain operations. Unless specifically stated in the description, embodiments are not necessarily limited to any particular order of carrying out such operations. In particular, the labels are used merely for convenient identification of operations, and are not intended to specify or require a particular order of carrying out such operations.

1. A method of allocating digital storage space from a shared storage pool comprising physical storage from a plurality of data storage devices of a data storage system, the method comprising:
allocating a first one or more slabs of storage from a first set of the plurality of data storage devices to a first virtual device having a first redundancy level; and
allocating a second one or more slabs of storage from a second set of the plurality of data storage devices to a second virtual device having a second redundancy level, wherein:
at least one of the first slabs and at least one of the second slabs is from a same data storage device, and
the second redundancy level is different from the first redundancy level;
in response to freeing of a set of blocks from the first one or more slabs corresponding to the first virtual device, returning to the storage pool the set of blocks;
allocating a third one or more slabs of storage from a third set of the plurality of data storage devices to a third virtual device having a third redundancy level different from the first redundancy level, wherein the third one or more slabs includes the set of blocks; and
in response to a write request corresponding to the third virtual device, allocating the set of blocks from the third one or more slabs to fulfill the write request corresponding to the third virtual device.

2. The method of claim 1, further comprising:
in response to a write request corresponding to the first virtual device, allocating a plurality of blocks from the first one or more slabs to fulfill the write request corresponding to the first virtual device; and
in response to a write request corresponding to the second virtual device, allocating a plurality of blocks from the second one or more slabs to fulfill the write request corresponding to the second virtual device.

3. The method of claim 2, wherein:
the first virtual device is associated with a first application operating as a client of the data storage system; and
the second virtual device is associated with a second different application operating as a client of the data storage system.

4. (canceled)

5. The method of claim 1, wherein allocating the first one or more slabs comprises:
determining a number of the one or more slabs to meet a corresponding allocation request; and
determining a minimum number of the first set of the plurality of data storage devices to meet the first redundancy level.

6. The method of claim 1, further comprising:
increasing performance corresponding to the first virtual device by allocating one or more slabs of storage from an adjusted first set of the plurality of data storage devices to the first virtual device, wherein the adjusted first set comprises more data storage devices than the first set.

7. The method of claim 1, further comprising:
maintaining, in at least one of the plurality of data storage devices not included in the first and second sets of data storage devices, a mapping of the respective plurality of blocks allocated from the first one or more slabs and from the second one or more slabs and to which of the first and second virtual devices each of the first and second slabs corresponds.

8. The method of claim 1, further comprising:
maintaining, in at least one of the plurality of data storage devices not included in the first and second sets of data storage devices, a mapping of from which of the plurality of data storage devices each of the first and second slabs is allocated.

9. The method of claim 1, further comprising:
creating a respective volume or filesystem corresponding to each of the first and second virtual devices.

10. A data storage system comprising:
a plurality of data storage devices; and
a system controller circuitry comprising memory and one or more processors and embodying one or more sequences of instructions which, when executed by the one or more processors, cause performance of:
allocating a first one or more slabs of storage from a first set of the plurality of data storage devices to a first virtual device having a first redundancy level; and
allocating a second one or more slabs of storage from a second set of the plurality of data storage devices to a second virtual device having a second redundancy level, wherein:
at least one of the first slabs and at least one of the second slabs is from a same data storage device, and
the second redundancy level is different from the first redundancy level;
in response to freeing of a set of blocks from the first one or more slabs corresponding to the first virtual device, returning to the storage pool the set of blocks;
allocating a third one or more slabs of storage from a third set of the plurality of data storage devices to a third virtual device having a third redundancy level different from the first redundancy level, wherein the third one or more slabs includes the set of blocks; and
in response to a write request corresponding to the third virtual device, allocating the set of blocks from the third one or more slabs to fulfill the write request corresponding to the third virtual device.

11. The data storage system of claim 10, wherein the one or more sequences of instructions, when executed, cause further performance of:
in response to a write request corresponding to the first virtual device, allocating a plurality of blocks from the first one or more slabs to fulfill the write request corresponding to the first virtual device; and
in response to a write request corresponding to the second virtual device, allocating a plurality of blocks from the second one or more slabs to fulfill the write request corresponding to the second virtual device.

12. The data storage system of claim 11, wherein:
the first virtual device is associated with a first application operating as a client of the data storage system; and
the second virtual device is associated with a second different application operating as a client of the data storage system.

13. (canceled)

14. The data storage system of claim 10, wherein the one or more sequences of instructions, when executed, cause further performance of:
determining a number of the one or more slabs to meet a corresponding allocation request; and
determining a minimum number of the first set of the plurality of data storage devices to meet the first redundancy level.

15. The data storage system of claim 10, wherein the one or more sequences of instructions, when executed, cause further performance of:
increasing performance corresponding to the first virtual device by allocating one or more slabs of storage from an adjusted first set of the plurality of data storage devices to the first virtual device, wherein the adjusted first set comprises more data storage devices than the first set.

16. The data storage system of claim 10, wherein the one or more sequences of instructions, when executed, cause further performance of:
maintaining, in at least one of the plurality of data storage devices not included in the first and second sets of data storage devices, a mapping of the respective plurality of blocks allocated from the first one or more slabs and from the second one or more slabs and to which of the first and second virtual devices each of the first and second slabs corresponds.

17. The data storage system of claim 10, wherein the one or more sequences of instructions, when executed, cause further performance of:
maintaining, in at least one of the plurality of data storage devices not included in the first and second sets of data storage devices, a mapping of from which of the plurality of data storage devices each of the first and second slabs is allocated.

18. The data storage system of claim 10, wherein the one or more sequences of instructions, when executed, cause further performance of:
creating a respective volume or filesystem corresponding to each of the first and second virtual devices.

19. A data storage system comprising:
means for allocating a first one or more slabs of storage from a first set of the plurality of data storage devices to a first virtual device having a first redundancy level; and
means for allocating a second one or more slabs of storage from a second set of the plurality of data storage devices to a second virtual device having a second redundancy level, wherein:
at least one of the first slabs and at least one of the second slabs is from a same data storage device, and
the second redundancy level is different from the first redundancy level.

20. The data storage system of claim 19, further comprising:
means for allocating, in response to a write request corresponding to the first virtual device, a plurality of blocks from the first one or more slabs to fulfill the write request corresponding to the first virtual device; and
means for allocating, in response to a write request corresponding to the second virtual device, a plurality of blocks from the second one or more slabs to fulfill the write request corresponding to the second virtual device.
